(19) United States
(12) Patent Application Publication
(10) Pub. No.: US 2014/0220941 A1
(43) Pub. Date: Aug. 7, 2014

(54) VIRTUAL SPACE SHARING SYSTEM FOR MOBILE PHONES

(71) Applicant: NEC CASIO MOBILE COMMUNICATIONS, LTD., Kawasaki-shi (JP)

(72) Inventor: Keisuke ABE, Kawasaki-shi (JP)

(73) Assignee: NEC CASIO MOBILE COMMUNICATIONS, LTD., Kawasaki-shi (JP)

(21) Appl. No.: 13/760,259

(22) Filed: Feb. 6, 2013

(51) Int. Cl. H04W 4/16

(52) U.S. Cl. CPC H04W 4/16
USPC 455/414.1

(57) ABSTRACT

A virtual space sharing system controls a plurality of mobile phones to synchronize with each other so as to share a virtual space therebetween. Each mobile phone is designed to measure its position, movement, and tilt, to transmit its operational information to the counterpart mobile phone, and to display image data representing an object in the virtual space on screen. The mobile phones are calibrated so as to share a reference point in the coordinate system of the virtual space in advance. The mobile phones communicate with each other so as to mutually exchange their operational information in real time. Each mobile phone is designed to calculate its relative position in the virtual space based on its physical position in the real space. When each mobile phone updates image data, the updated image data is automatically reflected in the counterpart mobile phone displaying the same object in the virtual space in real time.

### BACKGROUND OF THE INVENTION

1. Field of the Invention

The present invention relates to a virtual space sharing system which allows a plurality of mobile phones to share information in a single virtual space.

The present application is based on Japanese Patent Application No. 2010-251575 filed Nov. 10, 2010, the entire content of which is incorporated herein by reference.

2. Description of the Related Art

Recently, information processing devices with telecommunicating functions, such as mobile phones, smart phones, portable terminal devices, personal computers, and tablet computers, have been developed to further improve their functionality in terms of mutual communication using virtual space over a network. For example, Patent Literature 1 discloses a mobile information terminal device which aims to improve usability and visibility in browsing information over a network. The mobile information terminal device is equipped with a movement detector for detecting user's movement with an operation display unit, thus smoothly moving an object in a virtual space. Patent Literature 2 discloses a mobile information terminal device equipped with a touch panel and a movement detector for detecting acceleration of user's movement, thus determining a position in a virtual space. Patent Literature 3 discloses an information providing system which allows a plurality of mobile phones to access a virtual space, thus sharing information over a network. Patent Literature 4 discloses a social network system which allows a plurality of mobile phones to manipulate their characters in a virtual space over a network.

However, the conventional technologies fail to provide sophisticated functionality for a plurality of mobile phones in mutually sharing information and individually manipulating information in a virtual space over a network.

### CITATION LIST

### Patent Literature

Patent Literature 1: Japanese Patent Application Publication No. 2001-117553
Patent Literature 2: Japanese Patent Application Publication No. 2001-117694
Patent Literature 3: Japanese Patent Application Publication No. 2002-73517
Patent Literature 4: Japanese Patent Application Publication No. 2010-187899

### SUMMARY OF THE INVENTION

It is an object of the present invention to provide a virtual space sharing system which allows a plurality of mobile phones to share and manipulate information in a virtual space over a network.

The present invention is directed to a virtual space sharing system for a plurality of mobile phones sharing a single virtual space. The virtual space sharing system includes a state detecting part for detecting a change of state physically occurring in the real space with respect to each mobile phone; a position determining part for determining an initial position, corresponding to a reference point in the coordinate system of the virtual space, with respect to mobile phones; and a position calculating part for calculating a relative position of each mobile phone in the coordinate system of the virtual space based on the change of state physically occurring in the real space.

In another aspect, the present invention is directed to a mobile phone which is allowed to access a single virtual space shared by a counterpart mobile phone. The mobile phone includes a state detecting part for detecting a change of state physically occurring in the real space; a position determining part for determining an initial position, corresponding to a reference point in the coordinate system of the virtual space; and a position calculating part for calculating a relative position in the coordinate system of the virtual space based on the change of state physically occurring in the real space.

In a further aspect, the present invention is directed to a virtual space sharing method for a plurality of mobile phones sharing a single virtual space. The virtual space sharing method comprises the steps of: detecting a change of state physically occurring in the real space with respect to each mobile phone; determining an initial position, corresponding to a reference point in the coordinate system in the virtual space, with respect to mobile phones; and calculating a relative position of each mobile phone in the coordinate system of the virtual space based on the change of state physically occurring in the real space; calculating image data representing an object in the virtual space based on the relative position of each mobile phone in the coordinate system of the virtual space; displaying image data in the virtual space with each mobile phone; synchronizing mobile phones such that operational information, representing manual operation applied to one mobile phone, is reflected in another mobile phone in real time; and updating image data of the object in the virtual space based on the operational information, thus allowing mobile phones to display the updated image data of the object in the virtual space.

The present invention allows each of mobile phones, sharing a single virtual space, to manipulate an object displayed in the virtual space, to mutually exchange operational information reflecting its visual aspect, and to automatically update image data based on operational information of other mobile phones in real time.

### BRIEF DESCRIPTION OF THE DRAWINGS

These and other objects, aspects, and embodiments of the present invention will be described in more detail with reference to the following drawings.

FIG. 1 is a conceptual illustration explaining the functionality of a virtual space sharing system implementing a plurality of mobile phones according to an embodiment of the present invention.

FIG. 2 is a front view of a mobile phone with functional blocks.

FIG. 3 is a conceptual illustration of a virtual space shared by a plurality of mobile phones.

FIG. 4 is a flowchart showing a virtual space sharing process executed by the mobile phones which communicate with each other.

FIG. 5A shows a plurality of mobile phones which are physically overlapped with each other in steps S1, S2.

FIG. 5B shows a mobile phone moved from one place to another place.

FIG. 5C shows a mobile phone capturing an image of an object in a virtual space.

FIG. 5D shows a mobile phone manipulating an image of an object in a virtual space.

FIG. 5E shows a mobile phone updating an image of an object, which is reflected in another mobile phone, in a virtual space.

### DESCRIPTION OF THE PREFERRED EMBODIMENT

The present invention will be described in further detail by way of examples with reference to the accompanying drawings.

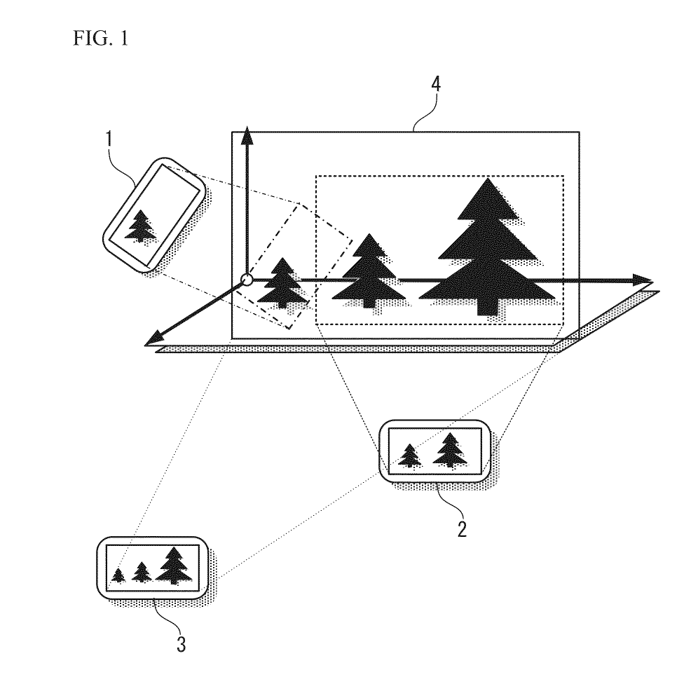

FIG. 1 is a conceptual illustration explaining the functionality of a virtual space sharing system according to an embodiment of the present invention. The virtual space sharing system is implemented using a plurality of mobile phones 1, 2, 3 which operate according to programs and which store information representing a virtual space 4.

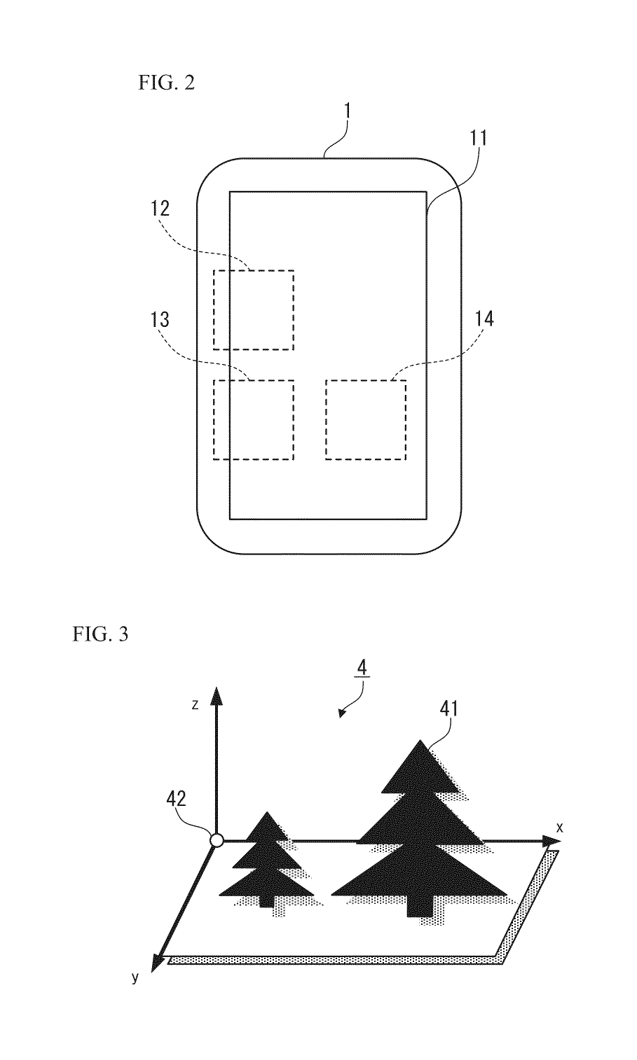

FIG. 2 is a front view of the mobile phone 1 with functional blocks encompassed using dotted lines. The mobile phone 1 has the same configuration as the other mobile phones 2 and 3. The mobile phone 1 includes a display 11, an acceleration sensor 12, a communication part 13 (which may operate according to any wireless communication standard such as Bluetooth), and a CPU 14 (or a processor). The display 11 displays image information, processed by the CPU 14, on screen.

The acceleration sensor 12 has a function to measure the three-dimensional movement of the mobile phone 1 in X-axis, Y-axis, and Z-axis directions as well as tilt information representing a tilt angle of the mobile phone 1. The communication part 13 has a function to wirelessly transmit positional information, detected by the mobile phone 1, and operation information, representing user's operation in the virtual space 4 with the mobile phone 1, to the other mobile phones 2 and 3. Therefore, the mobile phones 1, 2, 3 are able to mutually share information among them. The CPU 14 has a function to control the display 11, the acceleration sensor 12, and the communication part 13 according to programs installed in memory (not shown). The present embodiment is designed on precondition that the mobile phones 1, 2, 3 are able to carry out wireless communication directly without relaying communications via base stations, however, the mobile phones 1, 2, 3 may communicate with each other via base stations.

FIG. 3 is a conceptual illustration of the virtual space 4 which is shared by the mobile phones 1, 2, 3. The virtual space 4 is a three-dimensional space defined in X, Y, and Z axes, locating an object 41 at a position defined based on a reference point 42. Spatial information representing the virtual space 4 may be stored in the mobile phones 1, 2, 3 in advance. Alternatively, the mobile phones 1, 2, 3 may receive spatial information from a server. The mobile phones 1, 2, 3 are each set to an initial state to initialize the virtual space 4. In the initial state, an initial position and a viewpoint direction are set to the virtual space 4. The viewpoint direction is a direction from the initial position to the object 41 in the virtual space 4. The mobile phones 1, 2, 3 may produce an image in the viewpoint direction from the initial position in the virtual space 4. The spatial information locates the object 42 at a certain point of coordinates based on an origin of coordinates corresponding to the reference point 42 in the virtual space 4. The spatial information describes the initial position, the viewpoint direction, and the position (i.e. a certain point of coordinates) at which the object 41 is located in the virtual space 4. The CPU 14 included in each of the mobile phones 1, 2, 3 executes a virtual space sharing program to perform the following processes using the initial position, the viewpoint direction, and the position of the object 41 in the virtual space 4.

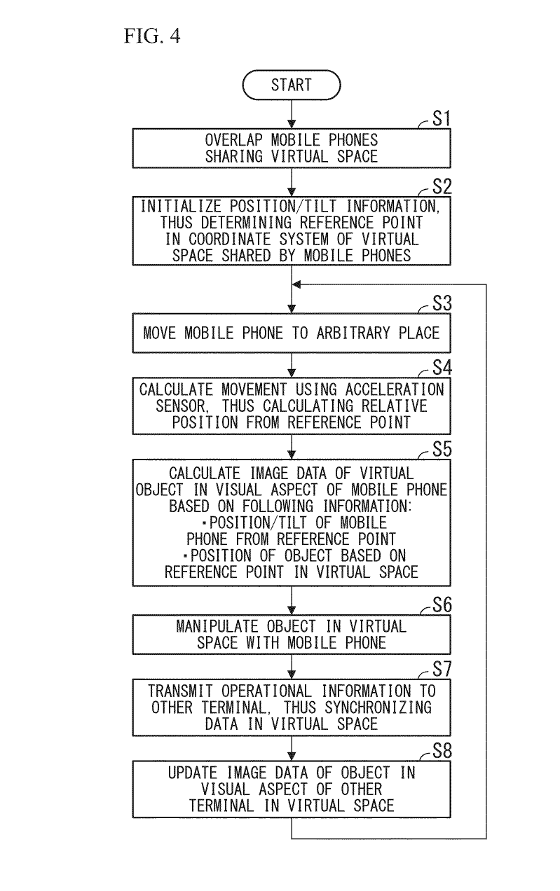

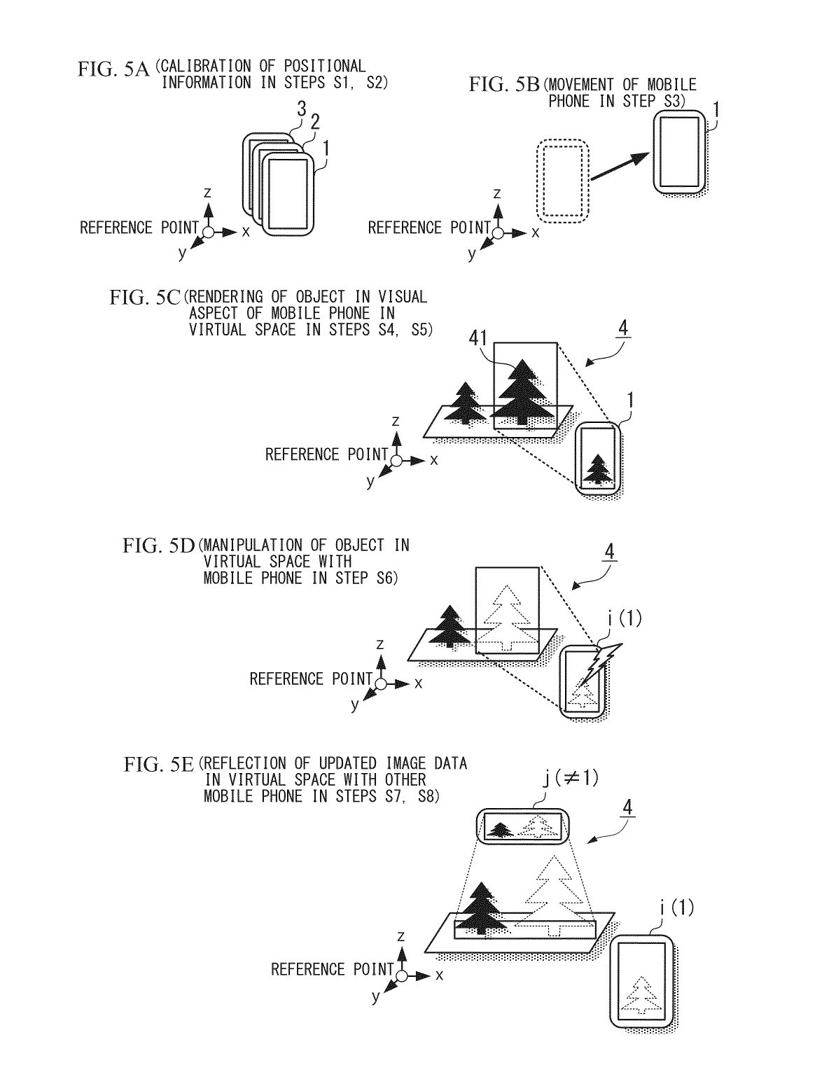

FIG. 4 is a flowchart showing a virtual space sharing process executed by the mobile phones 1, 2, 3 which communicate with each other, while FIGS. 5A-5E are drawings explaining a series of operations executed by the mobile phones 1, 2, 3 in connection with steps S1 to S5 shown in FIG. 4. In step S1, the mobile phones 1, 2, 3, which cooperate with each other to share the virtual space 4, are physically overlapped with each other as shown in FIG. 5A. In step S2, the mobile phones 1, 2, 3 are each initialized in terms of the positional information and the tilt information, thus determining an initial point (or a reference point) in a coordinate system representing the virtual space 4. Any user may initialize the mobile phones 1, 2, 3 by way of triggering or the like. For example, any user may press certain buttons on the mobile phones 1, 2, 3 which are physically overlapped with each other. Alternatively, any user may conduct synchronized communication from one mobile phone, receiving an initialization instruction, to another mobile phone. Thus, the mobile phones 1, 2, 3 are each controlled to produce an image, which is observed from the initial position in the viewpoint direction in the virtual space 4, by way of the known technique and then to display it on screen.

Next, the mobile phones 1, 2, 3 are each moved to an arbitrary position in step S3. FIG. 5B shows that the mobile phone 1 is moved from one place to another place. In step S4, each mobile phone measures a distance, by which it is moved from the reference point, with the acceleration sensor 12, thus calculating a relative position measured from the reference point. In step S5, each mobile phone calculates an visual aspect how the object 41 is observed in the virtual space 4 based on the positional information (i.e. the position of each mobile phone distanced from the reference point) and the tilt information (i.e. a tilt angle of each mobile phone compared to the coordinate system) as well as the position of the object 41 in the virtual space 4, thus displaying an image (reflecting the visual aspect of each mobile phone) on the screen of the display 11. Herein, the position of the object 41 in the virtual space 4 is preprogrammed in advance. The visual aspect of the object 41 viewed from each mobile phone is two-dimensional information as to how the object 41 is viewed with the two-dimensional screen of the display 11. FIG. 5C shows that the mobile phone 1 virtually captures an image of the object 41 (e.g. a tree-like image) in its visual aspect with the screen of the display 11.

For the sake of convenience, the mobile phones 1-3 are classified into a mobile phone i (where i=1, 2, 3) and another mobile phone j. (where j=1, 2, 3, but j≠i). In step S6, any user may operate the mobile phone i to manipulate the object 41 in the virtual space 4 as shown in FIG. 5D. In step S7, the mobile phone i sends its operational information to the other mobile phone j, thus synchronizing their data in the virtual space 4. For example, any user may delete or move the object 41 in the virtual space 4. Alternatively, any user may add an arbitrary image as the object 41 in the virtual space 4. In step S8, the other mobile phone j may update image data of the object 41 in the virtual space 4 in synchronism with the mobile phone ii as shown in FIG. 5E. Specifically, the mobile phone i produces operational information due to user's operation and then sends it to the other mobile phone j, thus allowing the other mobile phone j to update image data based on operational information. After completion of step S8, the flow returns to step S3 so that each mobile phone may repeat a series of steps S3 to S8. Thus, it is possible to reflect users' manual operations applied to the mobile phones 1-3 in a single virtual space 4 in real time. Additionally, it is possible to automatically reflect any variation of the virtual space 4 in the mobile phones 1-3 in real time; hence, the mobile phones 1-3 may refer to any variation currently occurring in the virtual space 4 in real time.

In the above, the mobile phones 1-3 are each controlled to synchronize with each other in terms of operational information regarding the object 41 in the virtual space 4; but this is not a restriction. The mobile phones 1-3 can be each controlled to share positional information of other mobile phones.

The present invention is not necessarily limited to the foregoing configuration and operation, which can be further modified in various ways within the scope of the invention as defined by the appended claims. In short, the present embodiment may demonstrate various effects as follows.
(1) A plurality of mobile phones is subjected to calibration so as to share the coordinate system of a virtual space in advance. This makes it possible for a plurality of mobile phones to be continuously synchronized with each other in terms of operational information of an object which may be updated in a virtual space in real time. Thus, a plurality of mobile phones is allowed to concurrently share any information (e.g. operational information, positional information) in a single virtual space in real time.
(2) Each mobile phone is designed to calculate its relative position, relative to the reference point of a virtual space, and the position of an object relative to the reference point of a virtual space. Thus, it is possible for each mobile phone to update its visual aspect, as to how an object is observed from the position of each mobile phone in a virtual space, in real time.
(3) The virtual space sharing system of the present invention may allow multiple users to play games in a single virtual space in real time with a plurality of game devices (or mobile phones).

What is claimed is:

1. A virtual space sharing system for a plurality of mobile phones sharing a single virtual space, comprising:
a state detecting part which is configured to detect a change of state physically occurring in a real space with respect to each mobile phone among the plurality of mobile phones;
a position determining part which is configured to determine an initial position, corresponding to a reference point in a coordinate system of the virtual space, with respect to the plurality of mobile phones; and
a position calculating part which is configured to calculate a relative position of each mobile phone in the coordinate system of the virtual space based on the change of state physically occurring in the real space.

2. The virtual space sharing system according to claim 1, further comprising:
an image calculating part which is configured to calculate image data representing an object in the virtual space based on the relative position of each mobile phone in the coordinate system of the virtual space; and
a display part which is configured to display image data in the virtual space with each mobile phone.

3. The virtual space sharing system according to claim 2, further comprising:
a synchronizing part which is configured to synchronize the plurality of mobile phones such that operational information, representing manual operation applied to one mobile phone, is reflected in another mobile phone in real time; and
an updating part which is configured to update image data of the object in the virtual space based on the operational information, thus allowing the plurality of mobile phones to display the updated image data of the object in the virtual space.

4. The virtual space sharing system according to claim 1, wherein the state detecting part detects movement and tilt for each mobile phone among the plurality of mobile phones.

5. A mobile phone which is allowed to access a single virtual space shared by a counterpart mobile phone, said mobile phone comprising:
a state detecting part which is configured to detect a change of state physically occurring in a real space;
a position determining part which is configured to determine an initial position, corresponding to a reference point in a coordinate system of the virtual space; and
a position calculating part which is configured to calculate a relative position in the coordinate system of the virtual space based on the change of state physically occurring in the real space.

6. The mobile phone according to claim 5, further comprising:
an image calculating part which is configured to calculate image data representing an object in the virtual space based on the relative position in the coordinate system of the virtual space; and
a display part which is configured to display image data in the virtual space.

7. The mobile phone according to claim 6, further comprising:
a synchronizing part which is configured to establish synchronization with the counterpart mobile phone such that operational information representing manual operation is reflected in the counterpart mobile phone in real time; and
an updating part which is configured to update image data of the object in the virtual space based on the operational information, thus allowing the counterpart mobile phone to display the updated image data of the object in the virtual space.

8. The mobile phone according to claim 1, wherein the change of state represents movement and/or tilt.

9. A virtual space sharing method for a plurality of mobile phones sharing a single virtual space, comprising:
detecting a change of state physically occurring in a real space with respect to each mobile phone among the plurality of mobile phones;
determining an initial position, corresponding to a reference point in a coordinate system of the virtual space, with respect to the plurality of mobile phones; and
calculating a relative position of each mobile phone in the coordinate system of the virtual space based on the change of state physically occurring in the real space;
calculating image data representing an object in the virtual space based on the relative position of each mobile phone in the coordinate system of the virtual space;
displaying image data in the virtual space with each mobile phone;
synchronizing the plurality of mobile phones such that operational information, representing manual operation applied to one mobile phone, is reflected in another mobile phone in real time; and
updating image data of the object in the virtual space based on the operational information, thus allowing the plurality of mobile phones to display the updated image data of the object in the virtual space.

10. The virtual space sharing method according to claim 9, wherein the change of state represents movement and/or tilt for each mobile phone among the plurality of mobile phones.
